(19) United States
(12) Patent Application Publication
(10) Pub. No.: US 2007/0108167 A1
(43) Pub. Date: May 17, 2007

(54) Vacuum extraction unit for a device used to structure the surface of a workpiece by means of radiation

(75) Inventors: Klaus Kruckenhauser, Langkampfen (AT); Josef Juffinger, Thiersee (AT)

Correspondence Address: BIRCH STEWART KOLASCH & BIRCH, PO BOX 747, FALLS CHURCH, VA, 22040-0747, US

(73) Assignee: Stork Prints Austria GmbH, Langkampfen (AT)

(21) Appl. No.: 10/580,274

(22) PCT Filed: May 5, 2004
(86) PCT No.: PCT/EP04/04788

§ 371 Date: Jul. 17, 2006

(30) Foreign Application Priority Data
Nov. 27, 2003 (DE) 103 55 996.5

(51) Int. Cl. B23K 26/38; B23K 26/14

(52) U.S. Cl. 219/121.68; 219/121.84

(57) ABSTRACT

The invention relates to a vacuum unit for a device used to structure the surface of a workpiece (24), in particular a plate, such as e.g. a flexographic printing block, by means of radiation, in particular laser radiation, the workpiece being a cylinder or a plate that is located on a cylinder during the engraving process. Said unit comprises a hood (11) that covers an interaction zone between the radiation and the surface of the workpiece and that has a vacuum channel (12), whose inlet (15) lies opposite the surface of the workpiece in the operating position of the hood (11) and which can be connected to a vacuum line (38). The aim of the invention is to prevent the abraded and decomposition products that form during the machining of cylindrical workpieces, such as e.g. aerosols, vapour, fumes or gases from being released into the environment. To achieve this, the unit is also equipped with a C-shaped cover ring (13), which comprises two ends that that follow the circumference of the workpiece and are located at a distance from one another and which has a substantially U-shaped cross-section with two opposing lateral walls (18), which are interconnected by a base wall (19). The hood (11) is located between the two ends of the cover ring (13).

### DESCRIPTION

The invention relates to a vacuum extraction unit for a device used to structure the surface of a workpiece, in particular a printing form, such as for example a flexographic printing block, by means of radiation, in particular by means of laser radiation, the workpiece being a cylinder or a planar or curved plate which is arranged on a cylinder during the engraving.

In the processing of cylindrical workpieces or workpiece surfaces made of natural or artificial organic materials by means of radiation, in particular by means of laser radiation, the cylindrical workpiece is usually rotatably mounted in a corresponding processing machine. A processing head, for example a working laser head, is in this case arranged in such a way that it focuses radiation for processing the workpiece on its surface. In order to be able to process the entire surface of the cylinder, a relative movement between the workpiece and the processing head is envisaged, taking place parallel to the axis of rotation of the workpiece. In this case, either the processing head or the workpiece may be displaced in relation to the processing machine in the direction of the axis of rotation, while the workpiece or the processing head is fixedly arranged.

When structuring surfaces, for example when engraving a relief into a surface of workpiece, in particular made for example of natural rubber, synthetic rubber, thermoplastic elastomers or the like, by means of radiation, in particular by means of laser radiation, as is used for example for producing flexographic printing forms, material is abrasively removed by the effect of radiation to form the relief, abrasion and decomposition products, such as for example aerosols, fumes, vapor and/or small particles and the like being produced. In order to prevent these abrasion and decomposition products from becoming lodged in already engraved regions and impairing the fineness of the engraved pattern there, it is required that they are removed as completely as possible from the region where they are created. Furthermore, the decomposition products may also soil regions that are not engraved, whereby the engraving process is disturbed, or else contaminate the laser beam guiding elements, which likewise leads to an impairment of the engraving quality.

DE 299 80 010 U1 already discloses a processing head for a laser engraving or cutting device in which a nozzle-like lens holder, holding the focusing lens, is surrounded by a vacuum extraction hood, which is connected via a vacuum extraction line to a corresponding vacuum extraction unit. The processing head is equipped with at least two gas nozzles, one of which directs a gas jet obliquely into a region of a zone of interaction between the laser beam and the stamping plate to be engraved, while the other likewise directs an oblique gas jet against the stamping plate to be engraved, which impinges in the region between the processing point and the edge of the vacuum extraction hood in order to retard the radial spread of dust or other decomposition products during the processing of the stamping plate, so that they can be extracted via the vacuum extraction hood and not escape through a gap at the edge of the same.

EP 0 427 004 A2 discloses a device for processing hollow cylinders, in particular screen stencils, by means of a laser, in which the hollow cylinder to be processed is supported by rolls or tapered supporting rollers in its axial direction upstream and downstream of a zone of interaction between the laser beam and the hollow cylinder, that is to say upstream and downstream of an engraving site. In the case of this device, the laser processing head is preceded by a vacuum housing which is formed in such a way that the mouthpiece of the laser processing head is surrounded by the vacuum housing. This forms a vacuum chamber with an opening, the edge of which forms with the engraving cylinder a gap 34 which surrounds the engraving region, that is the zone of interaction between the laser beam and the stencil. Since air flowing in via the gap from the vacuum chamber is constantly extracted, the pressure difference between the surrounding atmosphere and the interior of the vacuum chamber is maintained, forcing the stencil into constant contact with the rolls or tapered supporting rollers.

The extraction of the air from the vacuum chamber, which serves the purpose of ensuring the pressure difference for the secure contact of the stencil against the supporting elements, is not sufficient however for the removal of abrasion and/or decomposition products.

EP 0 562 149 A1 further discloses a device for processing thin-walled hollow cylinders by means of a laser beam, in which a laser processing head is arranged alongside a hollow cylinder that is rotatably mounted about its longitudinal axis, such as for example a blank for a screen stencil or the like, on a carriage which is displaceable parallel to the longitudinal axis of the hollow cylinder to be processed. Along with the laser processing head, a supporting bearing for the hollow cylinder is fixedly mounted on the carriage, so that it can be moved together with the carriage in the axial direction of the hollow cylinder.

The supporting device comprises a lower bearing bracket substantially in the form of a half-circle and an upper bearing bracket in the form of a quarter-circle, which is pivotably mounted to permit the automatic loading of a hollow cylinder.

The lower bearing bracket, which may be equipped with a multiplicity of bearing rollers, has a substantially U-shaped profile, which is closed at the extreme ends so as to form a suction channel, which can be connected by means of a corresponding vacuum extraction connecting piece to a suitable vacuum extraction unit in order to produce a slight negative pressure in the suction channel, which ensures that the hollow cylinder is kept in reliable contact with the lower bearing bracket of the supporting device, in order to ensure reliable, vibration-free guidance of the hollow cylinder in its respective processing region, so that precise laser processing is possible.

Furthermore, in particular when processing organic materials, the material often continues to glow, which can be observed over a quarter or half revolution or more, and which consequently leads to fumes and/or vapor developing outside the extraction region. Even in the case of nonorganic materials, such as zinc for example, continued glowing may occur, leading to decomposition products occurring not only close to the region of interaction of the radiation and the workpiece.

Although such fumes or vapor can be prevented from escaping into the environment by complete encapsulation of the processing machine, they then lead to the machine itself becoming soiled.

The invention is based on the object of providing a further vacuum extraction unit of the type mentioned at the beginning with which abrasion and decomposition products created during the processing of cylindrical workpieces, such as for example aerosols, vapors, fumes, gases and the like, are prevented from escaping into the environment.

This object is achieved by the vacuum extraction unit as claimed in claim 1. Advantageous refinements and developments are described in the subclaims.

Therefore, according to the invention, a vacuum extraction unit has a hood for covering a region of interaction between the radiation and the workpiece surface and a C-shaped cover ring. The hood thereby comprises a vacuum extraction channel, the inlet opening of which lies opposite the workpiece surface in the operating position of the hood and can be connected to a vacuum extraction line. The C-shaped cover ring comprises two ends that follow the circumference of the workpiece and are located at a distance from each other, and has a substantially U-shaped cross section, the hood being arranged adjacent one of the two circumferential ends of the cover ring.

The arrangement according to the invention of a cover ring which extends at least partially around a cylindrical workpiece has the effect of forming an annular channel between the cover ring and the cylindrical workpiece, in which channel a circumferential air flow forms on account of the rotation of the workpiece during processing and is extracted by means of the hood arranged adjacent one end of the cover ring. In principle, it is also conceivable to provide the cover ring with an extraction means of its own, for example in its outer circumferential region.

The C-shaped cover ring may in this case extend partially or virtually completely around a cylindrical workpiece. In the latter case, its two circumferential ends lie adjacent the hood. In the former case, it may extend over 90°, 120°, 180° or any other angular range which is adequate to allow fumes, vapors, small particles or the like to be captured and extracted.

It is preferred, however, that the cover ring extends so far around the workpiece that the hood then lies between its circumferential ends and extracts the flow there, so that a certain negative pressure is created in the annular channel, on account of which its air is sucked in through the intermediate space between the side walls of the cover ring and the workpiece, so that fumes, vapors or gases which are given off from the workpiece underneath the cover ring on account of the processing of the material can be reliably prevented from penetrating to the outside. Rather, the fumes, vapors or other gases are taken up by a circumferential flow on account of the rotation of the workpiece and carried to the hood of the vacuum extraction unit, where they are transported away together with other abrasion and decomposition products from an engraving zone, that is from a region of interaction between the radiation and the workpiece surface.

In the case of an advantageous development of the invention, it is provided that the C-shaped cover ring is exchangeable, so that when processing cylindrical workpieces with different diameters a cover ring from a number of cover rings is respectively chosen and used, the inside diameter of which ring is adapted as well as possible to the diameter of the cylindrical workpiece respectively to be processed. In this way, optimum sealing can be achieved for fumes, vapors or the like.

According to another refinement of the invention, it is also possible that the side walls of the C-shaped cover ring are provided with means for reducing its free inside diameter, so that said ring can be set to correspond to the diameter of the cylindrical workpiece respectively to be processed, the means for reducing the free inside diameter of the C-shaped cover ring preferably comprising a lamellar seal, the individual lamellae of which are pivotably fastened to the side walls of the cover ring. This arrangement permits very flexible adaptation of the cover ring to different workpiece diameters.

The means for reducing the free inside diameter of the C-shaped cover ring may, however, also be formed by exchangeable side parts, in particular side plates.

A particularly advantageous development of the invention is distinguished by the fact that the C-shaped cover ring is circumferentially subdivided into at least two ring segments, which are pivotably held against each other.

In this case it is particularly expedient if the C-shaped cover ring is circumferentially subdivided into three ring segments of different circumferential lengths, the circumferential length of an upper ring segment corresponding approximately to half the circumferential length of the cover ring, while the lower ring portion has two shorter ring segments.

To improve the extraction of the air from the annular channel formed by the cover ring, it is advantageous if a vacuum extraction nozzle is arranged in an intermediate space between the hood and a circumferential end of the C-shaped cover ring that is located upstream of the hood.

According to another development of the invention, it is provided that the hood has a rear side to which a vacuum extraction line can be connected, two side walls, which have end edges which lie opposite the workpiece in the operating position of the hood, and two directing walls, which are located between the side walls, extend transversely in relation to the latter and which together with the two side walls delimit the vacuum extraction channel in the hood, an edge of one of the two directing walls lying opposite the workpiece in the operating position of the hood, while the other directing wall has a convex, cylindrical curvature lying opposite the workpiece surface in the operating position of the hood and, in the region of this curvature, at least one opening, through which the radiation for processing the workpiece surface is guided. As a result, a high extraction rate is ensured in the region of interaction between the radiation and the workpiece.

A further refinement of the invention is distinguished by the fact that the hood has a rear side, to which a vacuum extraction line can be connected, two side walls, which have end edges with a contour which is adapted to the contour of the surface of a workpiece to be processed, so that corresponding gap seals are formed when the end edges lie opposite the workpiece in the operating position of the hood, and two directing walls, which are located between the side walls, extend transversely in relation to the latter and which together with the two side walls delimit the vacuum extraction channel in the hood, the hood being provided with an opening, through which the radiation for processing the workpiece surface is guided. As a result, particularly good extraction is achieved in the engraving region.

In this case, it is expediently provided that an edge of one of the two directing walls lies opposite the workpiece in the operating position of the hood, while the other directing wall has a convex, cylindrical curvature lying opposite the workpiece surface in the operating position of the hood, and that the at least one opening, through which the radiation for processing the workpiece surface is guided, is arranged in the region of the curvature of the other directing wall.

The curvature of the curved directing wall is advantageously curved in the form of an arc of a circle, the curving of the curvature of the curved directing wall being greater than the curving of the surface of the workpiece. The curvature of the curved directing wall may, however, also be exponentially curved, in order to set specific velocity profiles of the flow in the vacuum extraction channel.

Another development of the invention is distinguished by the fact that the opening or openings through which the radiation for processing the workpiece is guided is/are provided in the region of the curved directing wall that lies closest to the surface of the workpiece in the operating position of the hood.

A further refinement of the invention consists in that the end edges of the side walls have a contour which is adapted to the contour of the surface of a workpiece to be processed, so that corresponding gap seals are formed, the contour of the end edges of the side walls being a polyline or an arc of a circle that is adapted to the contour of the workpiece surface.

Here it is expedient if the distance between the end edges of the side walls and the workpiece surface in the operating position of the hood is less than 50 mm, preferably less than 30 mm, in particular less than 10 mm but greater than 0.5 mm, and with particular preference between 1 mm and 5 mm, it being possible to provide that the width of the gap seals formed between the end edges of the side walls and the workpiece surface lies in the range between 0.1 mm and 30 mm.

In order to ensure satisfactory flow conditions, in particular in the engraving region, it is expedient if the hood is exchangeably fastened to a working laser head, so that when processing cylindrical workpieces with different diameters a hood from a number of hoods is respectively chosen and fastened to the working laser head, the side walls of which hood have end edges with a contour which is adapted as well as possible to the contour of the surface of the workpiece respectively to be processed.

It is also possible, however, that the side walls of the hood are provided with means, in particular movable lamellae or exchangeable side parts, by which the contour of the edges of the side walls that lie opposite a workpiece can be changed in order to adapt them to the surface of the workpiece.

To adapt the hood to the respective processing head, it is provided that, in the region of the curved directing wall that lies closest to the surface of the workpiece in the operating position of the hood, each working jet or beam delivered by a processing head, in particular each working laser beam delivered by a working laser head, is provided with an opening of its own, through which the radiation for processing the workpiece is directed onto the latter.

The invention is explained in more detail below by way of example on the basis of the drawing, in which:

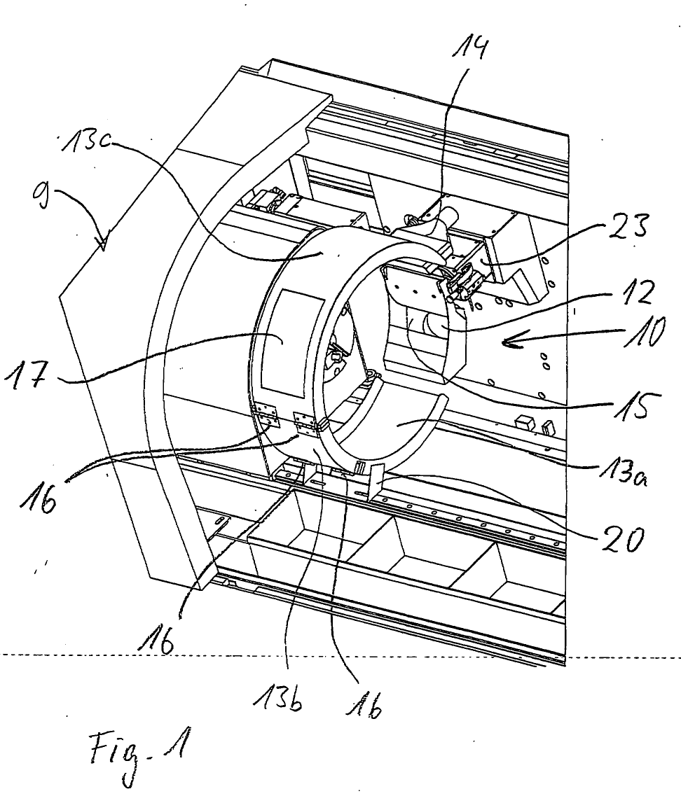

FIG. 1 shows a perspective view of part of a processing machine for a cylindrical workpiece by means of radiation, in particular laser radiation, which is equipped with a vacuum extraction unit according to the invention;

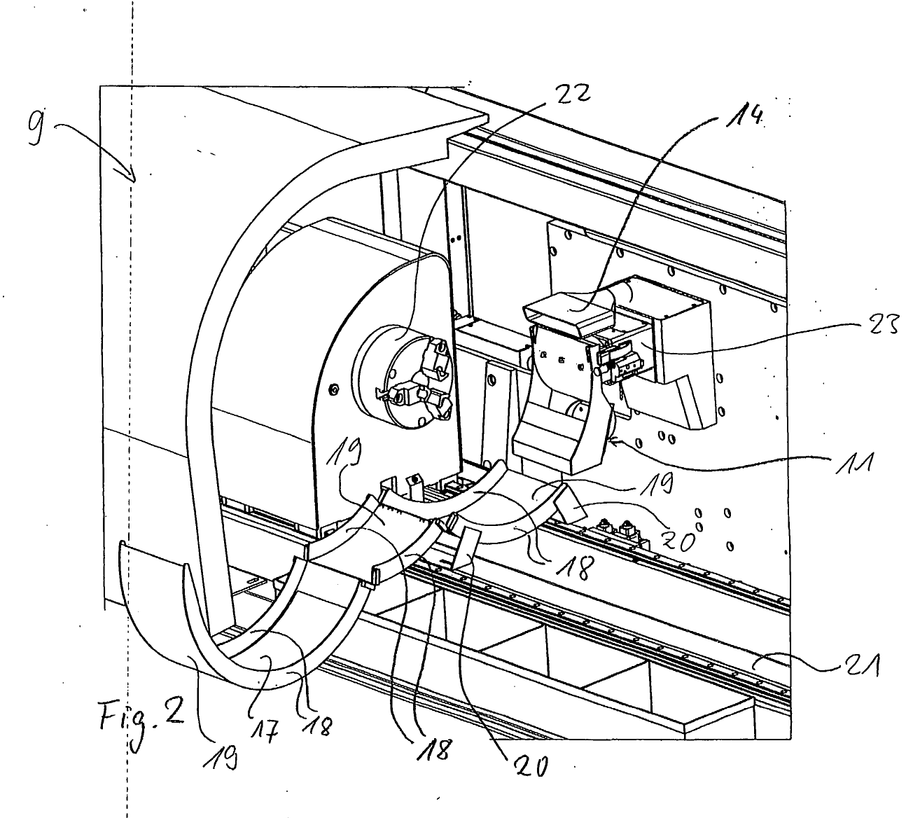

FIG. 2 shows a perspective view of the processing machine that is shown in FIG. 1, a three-element cover ring of the vacuum extraction unit being pivoted open forward, out of the machine, in order to make it easier for a cylindrical workpiece to be loaded into the processing machine;

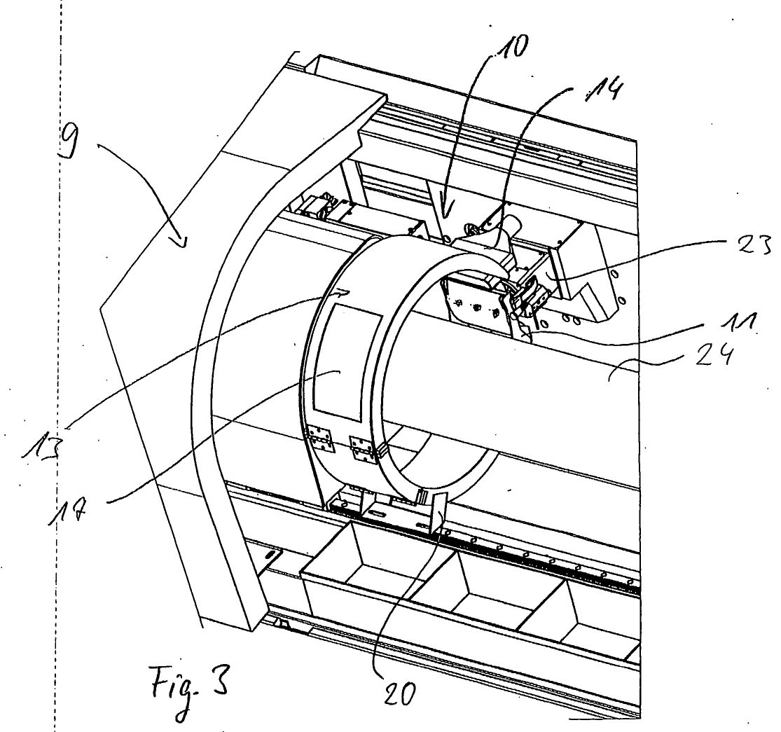

FIG. 3 shows a perspective view of the processing machine that is shown in FIG. 1 with a cylindrical workpiece loaded;

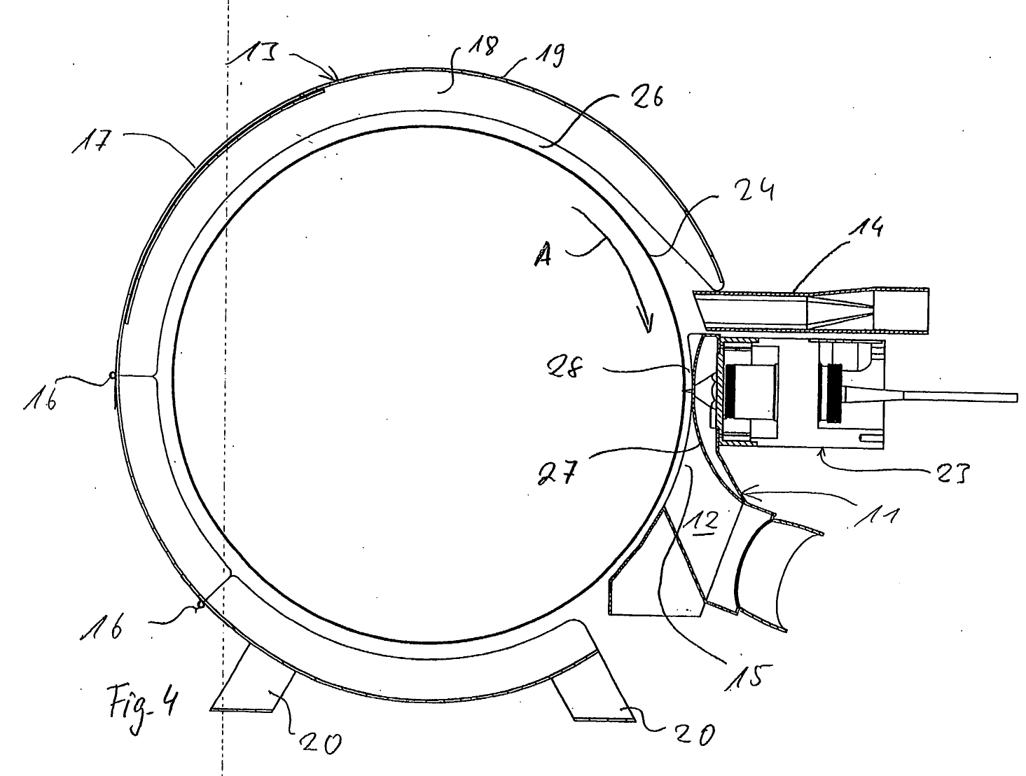

FIG. 4 shows a section through the vacuum extraction unit according to the invention with a cylindrical workpiece with a large diameter loaded in the processing machine;

FIG. 5 shows a section corresponding to FIG. 4, a workpiece with a small diameter having been loaded into the processing machine;

FIG. 6a shows a schematic section through a cylindrical workpiece with a small diameter with a cover ring of a vacuum extraction unit according to the invention arranged around it;

FIG. 6b shows a perspective representation of the arrangement that is shown in FIG. 6a;

FIG. 7 shows a representation corresponding to FIG. 6a with a workpiece with a large diameter;

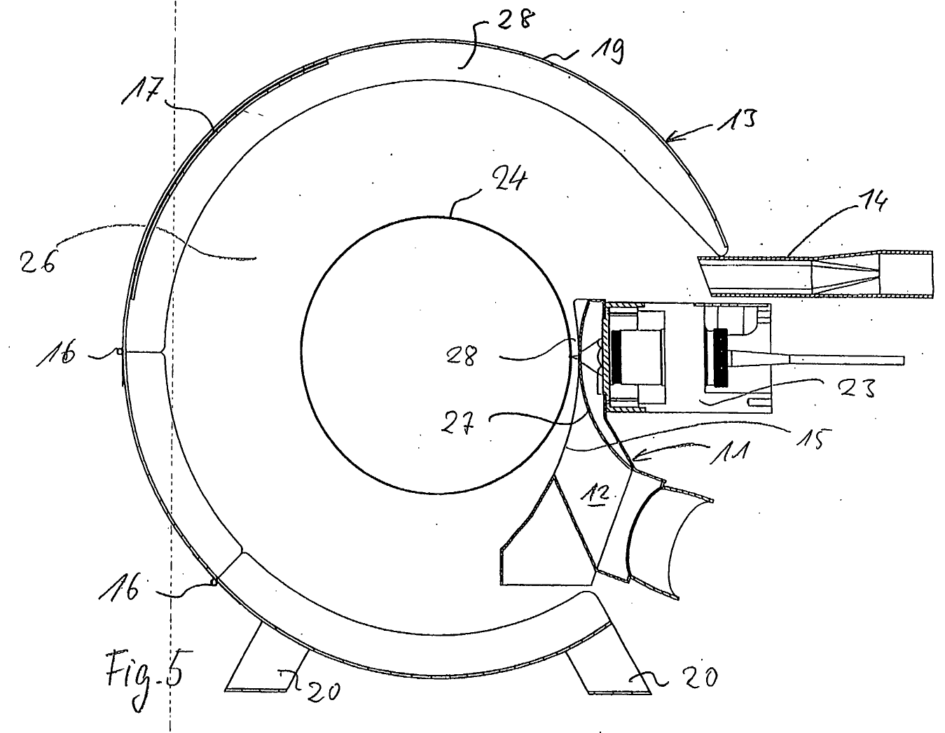

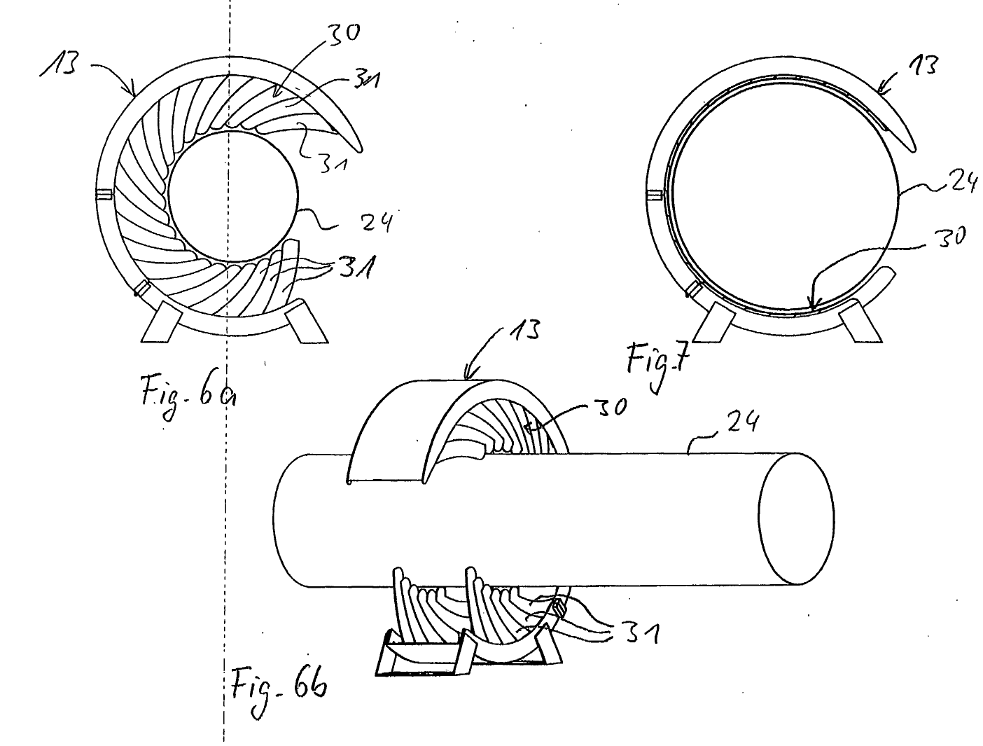

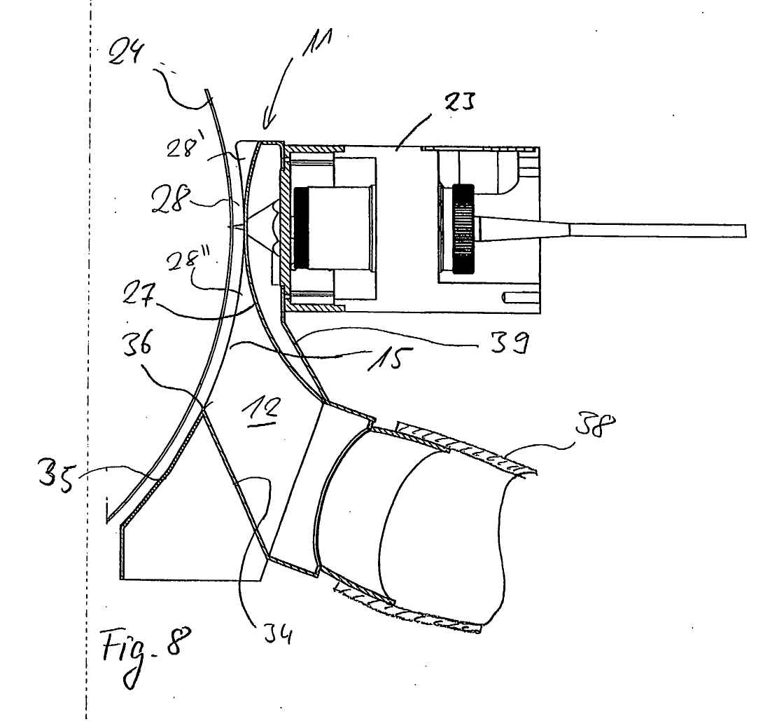

FIG. 8 shows a section through a processing head arranged opposite a cylindrical workpiece with a hood of the vacuum extraction unit according to the invention attached to it;

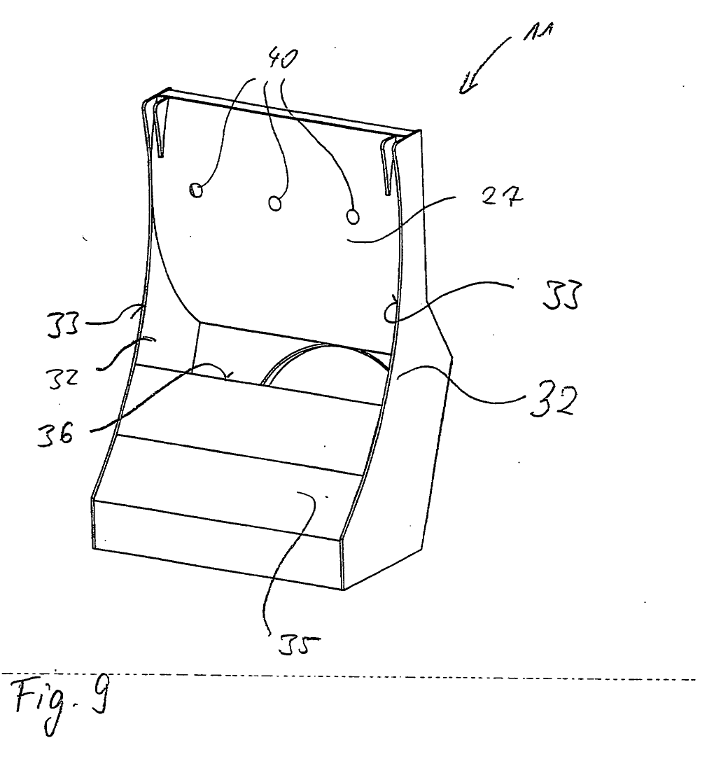

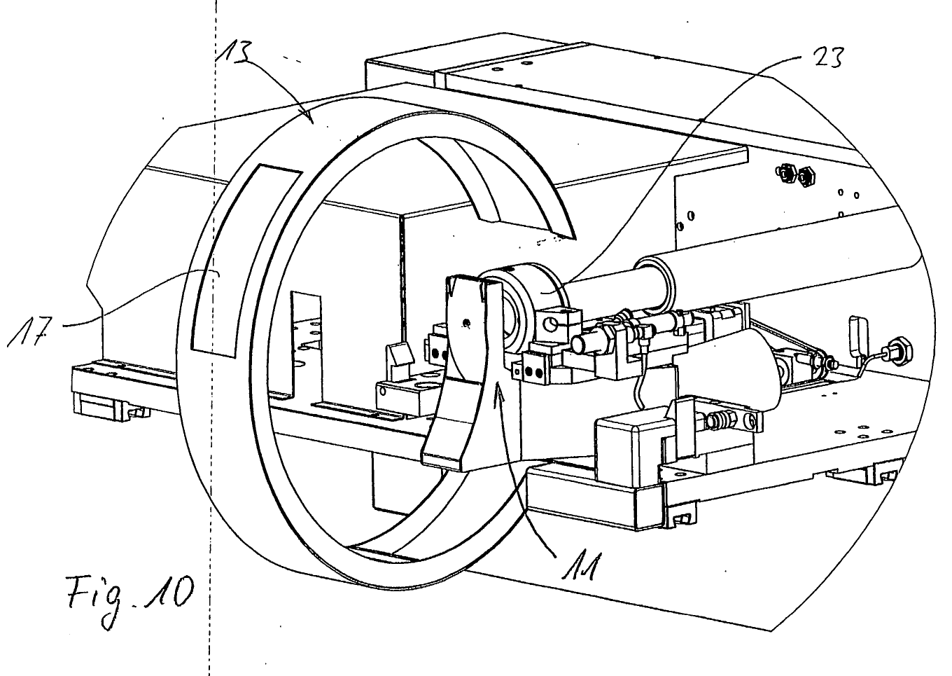

FIG. 9 shows a perspective front view of the hood of the vacuum extraction unit according to the invention; and

FIG. 10 shows a perspective representation of part of a processing machine with a vacuum extraction unit according to a second exemplary embodiment of the invention.

In the various figures of the drawing, components that correspond to one another are provided with the same designations.

As shown in FIG. 1, a processing machine 9 for a cylindrical workpiece (not represented in FIG. 1) is provided with a vacuum extraction unit 10, which has a hood 11 with a vacuum extraction channel 12, a C-shaped cover ring 13 and a vacuum extraction nozzle 14, arranged in FIG. 1 above the hood 11 in an intermediate space between the latter and a circumferential end of the cover ring 13.

The C-shaped cover ring 13 may in this case extend partially or virtually completely around a cylindrical workpiece. In the latter case, its two circumferential ends lie adjacent the hood. In the former case, it may extend over 90°, 120°, 180° or any other angular range which is sufficient to allow fumes, vapors, small particles or the like to be captured and extracted. In this case, the cover ring may also be provided with an extraction connection of its own, in order to extract decomposition products and the like directly.

In its operating position, the cover hood 11, which is explained in more detail below, covers a region of interaction between the working radiation and the workpiece surface, an inlet opening 15 of the vacuum extraction channel 12 lying opposite the workpiece surface in order to extract from the region of interaction material and decomposition products that are removed during the processing of the workpiece, such as for example aerosols, fumes, vapor, gas and the like.

The cover ring 13, which in principle, as represented in FIG. 10, may be formed by a single continuous C-shaped ring element, preferably however comprises two or three ring segments 13a, 13b and 13c, which are connected to one another by means of hinges 16, in order to allow it to be brought from the operating position represented in FIG. 1 into the open position represented in FIG. 2, in which the cover ring 13 releases the clamping region for the workpiece in order to make it easier to load the workpiece to be processed into the processing machine 9.

The upper cover ring portion 13c in FIG. 1 comprises a viewing window 17, which permits visual observation of the processing operation and processing progress. The viewing window 17 is closed in a sealed manner by a transparent material, such as for example glass or transparent plastic.

As can be seen particularly well in FIG. 2, the cover ring 13 or each of its ring portions 13a, 13b, 13c comprises two side walls 18 lying opposite each other and a bottom wall 19 connecting the latter, so that the cover ring 13 has a substantially U-shaped cross section.

The cover ring 13 may also comprise individual segments which are mounted independently of one another on a working head carrier or a machine bed. In this case, one or all the ring segments may also be connected to a separate vacuum extraction unit.

In the case of the processing machine 9 described, the cover ring 13 is fastened by means of supports 20 fixedly on a machine bed, which is only schematically indicated, while the receiving device for the cylindrical workpiece, which is only indicated in the drawing by one of two clamping heads 22, is mounted displaceably in the axial direction of the cylinder in the processing machine 9. A working head 23, which directs the working radiation, in particular the working laser beam, through corresponding openings in the hood 11 onto a workpiece surface, in particular focuses it, is likewise fixedly mounted in the processing machine 9 in the axial direction of the workpiece, but can be displaced radially in relation to the workpiece axis to compensate for different workpiece diameters. The working head 23 is in this case likewise fixedly mounted.

If the clamping heads 22 are fixedly mounted and the working head 23 is displaceably mounted, the vacuum extraction unit is also displaceable together with the working head 23.

Once a cylindrical workpiece 24 has been loaded into the processing machine 9, the cover ring 13 is closed, so that the cover ring 13 surrounds the cylindrical workpiece. If a workpiece with a relatively small diameter is concerned, the processing head 23, which carries the hood 11, is moved up to the workpiece, as shown in FIG. 5. If the workpiece has a large diameter, the situation that is represented in FIG. 4 arises for example, where the hood 11 of the vacuum extraction unit 10 that is held on the processing head 23 lies in the gap between the circumferential ends of the cover ring 13, so that this gap is substantially closed, while in the case of a cylindrical workpiece 24 with a small diameter the processing head 23 with the hood 11 passes through this gap until it has reached the processing position.

The function of the vacuum extraction unit according to the invention together with different workpiece diameters is explained in more detail below on the basis of FIGS. 4 to 7.

If, as represented in FIG. 4, a cylindrical workpiece 24 with a relatively large diameter is loaded into the processing machine 9, and if the cover ring 13 is in its closed position, the side walls 18 lie opposite the surface of the workpiece 24, separated from it by a gap 26, so that the cover ring 13 forms together with the covered workpiece surface an annular channel, which is in connection with the surroundings laterally via the gap 26.

If the workpiece rotates at high speeds during the processing of its surface by means of radiation, in particular by means of laser radiation, an air flow which corresponds to the direction of rotation of the workpiece 24 forms around the workpiece. In the case of the exemplary embodiment represented in FIG. 4, the cylindrical workpiece 24 rotates clockwise with respect to the direction in which the drawing is viewed, as indicated by the arrow A.

If, during the processing of the workpiece 24 with radiation, air is then extracted via the hood 11 from the region of interaction between the radiation and the workpiece 24, preferably with high capacity, in order to extract abrasion and decomposition products which are created during the processing, in particular during the engraving by means of radiation, the air sucked in flows through a suction gap 28, formed between a curved directing wall 27 and the workpiece surface 24, and further through the inlet opening 15 of the hood 11 in the vacuum extraction channel 12 of the latter. The air which is thereby sucked in is at the same time substantially replenished by the flow that is present in the annular channel between the cover ring 13 and the workpiece surface, whereby a certain negative pressure is created in the annular channel, so that replenishing air flows through the gaps laterally delimiting the annular channel. On account of this fact, fumes, vapor or other gases created in the region of the cover ring, forming as decomposition products for example as a result of continued glowing of the processed material, are transported by the annular flow in the annular channel to the extraction region, while the lateral flowing-in of air through the gaps 26 prevents fumes, vapor or gas escaping from the annular channel virtually completely.

If, as shown in FIG. 5, a cylindrical workpiece 24 with a relatively small diameter is to be processed in the processing machine 9, the processing head 23 with the hood 11 of the vacuum extraction unit 10 fastened to it is moved in a radial direction until the position represented in FIG. 5 is reached, in which the radiation from the processing head 23 is focused in the desired way on the surface of the workpiece 24 that is to be processed. In this position, the curved directing wall 27 again forms with the workpiece surface a suction gap 28, through which air is extracted with high capacity via the inlet opening 15 and the vacuum extraction channel 12 of the hood 11, in order to remove abrasion and decomposition products from the region of interaction between the radiation and the workpiece surface.

Since the workpiece has a relatively small diameter, the distance between the workpiece surface and the inner edge of the side walls 18 of the vacuum extraction channel is relatively great, so that the gap 26 has a relatively great width, which makes it difficult to build up a stable flow, directed into the interior of the annular channel, in the region of the gap 26. The vacuum extraction nozzle 24, which by contrast with the suction gap 28 lies radially on the outside, does in this case assist the build-up of a negative pressure underneath the cover ring 13. Nevertheless, as from a certain width of the gap 26, it is no longer sufficiently ensured that fumes and the like forming underneath the cover ring are reliably transported into the extraction region by the circulating flow.

In order to allow sufficient negative pressure to be produced in the annular channel between the cover ring 13 and the workpiece surface by the extraction of the annular flow via the vacuum extraction nozzle 14 and the vacuum extraction channel 12 in the hood 11 when the gaps 26 between the cover ring 13 and the workpiece surface have great widths, it is provided in the case of an advantageous development of the invention that sealing elements which move in such a way that, as shown in FIGS. 6a and 6b, they cover the gap or gaps 26 between the cover ring 13 and the surface of the workpiece 24 are arranged on the side walls 18 of the cover ring 13. In a way not represented in any more detail, the sealing elements may in this case be formed in a manner similar to an iris diaphragm of a camera. In the case of a preferred refinement, the sealing is formed as a lamellar seal 30, the individual lamellae of which are pivotably attached to the side walls 18 of the cover ring 13.

Consequently, in dependence on the diameter of the workpiece 24, the lamellae 31 can in each case be brought into such a position that the open side region, that is the gaps 26, can be made so small that a pressure difference between the annular channel and the surroundings that is sufficient to prevent fumes, vapor or gas escaping from the annular channel can be maintained.

However, it is also possible to provide additional side wall elements, which are assigned to a specific workpiece diameter, and to mount them on the side walls 18 as and when required.

Furthermore, it may be provided that the cover ring 13 is exchangeably mounted on the machine bed, and that cover rings 13 with different diameters are kept in readiness in order to adapt the vacuum extraction unit according to the invention to the respective workpiece diameter.

Although the vacuum extraction unit according to the invention does not require an especially structured vacuum extraction hood, it is nevertheless expedient if a hood 11 that has the structure described below is used, since a particularly rapid flow can be achieved as a result in the engraving region, that is in the region of interaction between the radiation and the workpiece surface, reliably entraining and removing the abrasion and decomposition products.

As represented in FIGS. 8 and 9, the hood 11 has two side walls 32, which have end edges 33 of a contour that is adapted to the outer circumference of the cylindrical workpieces 24. Accordingly, the end edges 33 have a substantially arcuate contour, which may be formed by a polyline or an arc of a circle so as to form between the end edges 33 and the workpiece 24 a gap seal, the sealing effect of which is all the better the smaller the distance between the end edge 33 and the surface of the workpiece 24 is.

This distance is expediently less than 50 mm, preferably less than 30 mm, and should be between 0.5 mm and 10 mm, in particular between 1 mm and 5 mm. In order to improve the sealing effect of the gap seals formed by the end edges 33 of the side walls 32 of the hood 11, it may be provided that the end edges have a greater width in the axial direction of the workpiece 24. The greater width of the end edges 33 may in this case be brought about by a greater thickness of the side walls 32. However, it is also possible to provide the side walls 32 in each case with a flange extending away from the inlet opening 15, in order to form wider gap seals. The width of the gap seals in this case expediently lies in the range from 0.1 mm to 20 or 30 mm.

In order to keep the distance between the end edges 33 and the surface of the workpiece 24 in the desired range even when, as represented in FIG. 5, a cylindrical workpiece with a relatively small diameter is to be processed, different hoods may be provided, the side walls of which have end edges with curvatures respectively adapted to a specific diameter range. However, it is also conceivable to provide the side walls with adjustable lamellar compartments, or exchangeable side parts with correspondingly formed end edges or the like, which in the case of greater distances between the end edges 33 and the workpiece surface can be pushed or arranged close to the latter.

The adaptation of the side walls to the workpiece contour allows lateral air inflow regions to be reduced to such an extent as to form in practice gap seals through which air which could disturb the air flow conditions inside the hood 11 is scarcely sucked in.

The curved directing wall 37 lies opposite a lower directing wall 34 in FIG. 8, which together with a further wall 35, lying opposite the workpiece surface, forms an edge 36 which is in the form of a sharp edge and together with the end edges 33 delimits the inlet opening 15 of the vacuum extraction channel 12 apart from in the region of the suction gap 28.

Provided on the rear side of the hood 11 is a connecting piece 37 for a vacuum extraction line 38, which is only indicated purely schematically in FIG. 8. Furthermore, the hood 11 has a mounting plate 39, with which it can be attached to the processing head 23 in such a way that the radiation for processing the workpiece surface can be focused through one or more openings 40 in the curved directing wall 27 on the surface of the workpiece 24.

The openings 40 are in this case arranged with respect to the curvature of the curved directing wall 27 in such a way that they lie in the narrowest region of the suction gap 28. However, it is also possible to offset the openings with respect to this narrowest region of the suction gap 28 in such a way that they are arranged slightly downstream of it in the direction of flow.

As can be clearly seen in FIG. 8, the suction gap 28 comprises upstream of its narrowest point a portion 28′ which narrows in the form of a funnel in cross section and downstream of the narrowest point in the direction of flow a region 28″ which widens once again in the form of a funnel. As can be seen in FIG. 9, directing ribs 32′ extending in the direction of flow are provided in the region of the portion 28′ of the suction gap 28 that narrows in the form of a funnel, adjacent but at a small distance from the side walls 32, in order to further smooth the air flow flowing in.

As a result of the described geometry of the suction gap 28 and on account of the gap seals formed by the end edges 33 of the side walls 32 and the wall 35, during vacuum extraction operation air is primarily sucked in through the suction gap 28 into the inlet opening 15 of the vacuum extraction channel 12. In the process, the flow sucked in is greatly accelerated on account of the narrowing gap, so that at the constriction of the suction gap 28 it can achieve extremely high flow velocities of up to about 150 to 180 m/s or higher. Apart from the high flow velocities, the structure of the hood 11 of the vacuum extraction unit according to the invention, that is in particular the structure of the walls delimiting the vacuum extraction channel 12 and the structure of the seals delimiting the inlet openings together with the configuration of the suction gap 28, ensures that a smooth flow with a high flow velocity and without vortices occurs in the suction gap 28 in particular, required for abrasion and decomposition products to be reliably transported away from the engraving region or region of interaction during the processing of the workpiece.

On account of the high extraction rates that are achieved by the special formation of the hood 11 described, particularly great extraction volumes can also be handled, which is of advantage for the formation of a negative pressure in the annular channel between the cover ring 13 and the workpiece surface 24.

Depending on which amounts of decomposition products and abraded material are to be reliably transported away during the laser processing, in particular laser engraving, not only must a rapid gas flow be achieved in the engraving region, but a sufficiently high volumetric flow rate must also be ensured. In this respect it must be taken into account that, with a rapid flow and high volumetric flow rate of the waste air, the decomposition products transported by it out of the engraving region tend to be deposited on the surface of the workpiece 24 or on the walls of the vacuum extraction channel 12 all the less the higher the flow velocity is and the lower the amount of material to be transported per cubic meter of volumetric flow is. It is therefore generally recommendable to use a volumetric flow rate of the waste air of at least 0.1 m³/g of degraded material. With preference, the volumetric flow rate is at least 0.5 m³/g, in particular at least 1.0 m³/g. In the case of a laser apparatus of average size, as is used in particular for the direct engraving of flexographic printing forms, engraving is carried out for example at a rate of 1 m²/h, which produces material abrasion of 500 to 1000 g/m². Accordingly, the vacuum extraction unit according to the invention should operate at an extraction rate of at least 50 to 100 m³/h, preferably at at least 250 to 500 m³/h and in particular at at least 500 to 1000 m³/h or more.

The vacuum extraction unit according to the invention has so far been described together with a processing head 23 which delivers three working jets or beams for processing the surface of a workpiece. However, it is also possible to adapt the vacuum extraction unit to processing heads which produce more or fewer working jets or beams. FIG. 10 shows for example a processing machine 9 with a vacuum extraction unit according to the invention in which the processing head delivers only a single working jet or beam, so that only one opening 40 has to be provided in the curved directing wall 27 of the hood 11. When there are more working jets or beams, openings 40 have to be provided in the curved directing wall in a number corresponding to the number of jets or beams.

The vacuum extraction unit according to the invention is not restricted to use on processing machines for the processing, in particular engraving, of printing forms or the like, but can be used everywhere where, during the laser processing of a cylindrical workpiece, decomposition and abrasion products have to be extracted from the circumferential region of a workpiece.

1. A vacuum extraction unit for a device used to engrave a relief into the surface of a workpiece (24), in particular into a printing element such as for example a flexographic printing element, by means of radiation, in particular laser radiation, the workpiece (24) being a cylinder or a plate which is arranged on a cylinder during the engraving, with
a hood (11), which covers a region of interaction between the radiation and the workpiece surface and comprises a vacuum extraction channel (12), the inlet opening (15) of which lies opposite the workpiece surface in the operating position of the hood and can be connected to a vacuum extraction line (38), and
a C-shaped cover ring (13) with two ends that follow the circumference of the workpiece and are located at a distance from each other, and has a substantially U-shaped cross section, the hood (11) being arranged adjacent one of the two circumferential ends of the cover ring (13) and extraction means (11, 14) being provided at the other circumferential end.

2. The vacuum extraction unit as claimed in claim 1, characterized in that the C-shaped cover ring (13) is exchangeable.

3. The vacuum extraction unit as claimed in claim 1, characterized in that the side walls (32) of the C-shaped cover ring (13) are provided with means for reducing its free inside diameter, so that said ring can be set to correspond to the diameter of the cylindrical workpiece (24) respectively to be processed.

4. The vacuum extraction unit as claimed in claim 3, characterized in that the means for reducing the free inside diameter of the C-shaped cover ring comprise a lamellar seal (30).

5. The vacuum extraction unit as claimed in claim 4, characterized in that the individual lamellae (31) of the lamellar seal (30) are pivotably fastened to the side walls (18) of the cover ring (13).

6. The vacuum extraction unit as claimed in claim 3, characterized in that the means for reducing the free inside diameter of the C-shaped cover ring comprise exchangeable side parts, in particular side plates.

7. The vacuum extraction unit as claimed in claim 1, characterized in that the C-shaped cover ring (13) is circumferentially subdivided into at least two ring segments (13a, 13b, 13c), which are pivotably held against each other.

8. The vacuum extraction unit as claimed in claim 7, characterized in that the C-shaped cover ring (13) is circumferentially subdivided into three ring segments (13a, 13b, 13c) of different circumferential lengths, the circumferential length of an upper ring segment (13c) corresponding approximately to half the circumferential length of the cover ring (13), while the lower ring portion has two shorter ring segments (13a, 13b).

9. The vacuum extraction unit as claimed in claim 1, characterized in that a vacuum extraction nozzle (14) is arranged as extraction means in an intermediate space between the hood (11) and the other circumferential end of the C-shaped cover ring (13) that is located upstream of the hood (11).

10. The vacuum extraction unit as claimed in claim 1, characterized in that the hood (11) has
a rear side to which a vacuum extraction line (38) can be connected,
two side walls (32), which have end edges (33) which lie opposite the workpiece (24) in the operating position of the hood (11), and
two directing walls (27, 34), which are located between the side walls (23), extend transversely in relation to the latter and which together with the two side walls (32) delimit the vacuum extraction channel (12) in the hood (11), an edge (36) of one (34) of the two directing walls lying opposite the workpiece in the operating position of the hood, while the other directing wall (27) has a convex, cylindrical curvature lying opposite the workpiece surface in the operating position of the hood and, in the region of this curvature, at least one opening (40), through which the radiation for processing the workpiece surface is guided.

11. The vacuum extraction unit as claimed in claim 1, characterized in that the hood (11)
has a rear side, to which a vacuum extraction line (38) can be connected,
two side walls (32), which have end edges (33) with a contour which is adapted to the contour of the surface of a workpiece (24) to be processed, so that corresponding gap seals are formed when the end edges (33) lie opposite the workpiece (24) in the operating position of the hood (11), and
two directing walls (27, 34), which are located between the side walls (32), extend transversely in relation to the latter and which together with the two side walls (32) delimit the vacuum extraction channel (12) in the hood (11), the hood (11) being provided with an opening (40), through which the radiation for processing the workpiece surface is guided.

12. The vacuum extraction unit as claimed in claim 11, characterized in that an edge (36) of one (34) of the two directing walls lies opposite the workpiece in the operating position of the hood, while the other directing wall (27) has a convex, cylindrical curvature lying opposite the workpiece surface in the operating position of the hood and in that the at least one opening (40), through which the radiation for processing the workpiece surface is guided, is arranged in the region of the curvature of the other directing wall (27).

13. The vacuum extraction unit as claimed in claim 10, characterized in that the curvature of the curved directing wall (27) is curved in the form of an arc of a circle.

14. The vacuum extraction unit as claimed in claim 13, characterized in that the curving of the curvature of the curved directing wall (27) is greater than the curving of the surface of the workpiece (24).

15. The vacuum extraction unit as claimed in claim 10, characterized in that the curvature of the curved directing wall (27) is exponentially curved.

16. The vacuum extraction unit as claimed in claim 10, characterized in that the opening or openings (40) through which the radiation for processing the workpiece (24) is guided is/are provided in the region of the curved directing wall (27) that lies closest to the surface of the workpiece (24) in the operating position of the hood (11).

17. The vacuum extraction unit as claimed in claim 10, characterized in that the end edges (33) of the side walls (32) have a contour which is adapted to the contour of the surface of a workpiece (24) to be processed, so that corresponding gap seals are formed.

18. The vacuum extraction unit as claimed in claim 10, characterized in that the contour of the end edges (33) of the side walls (32) is a polyline that is adapted to the contour of the workpiece surface.

19. The vacuum extraction unit as claimed in claim 10, characterized in that the contour of the end edges (33) of the side walls (32) is an arc of a circle that is adapted to the contour of the workpiece surface.

20. The vacuum extraction unit as claimed in claim 11, characterized in that the distance between the end edges (33) of the side walls (32) and the workpiece surface in the operating position of the hood (11) is less than 50 mm, preferably less than 30 mm, in particular less than 10 mm but greater than 0.5 mm, and with particular preference between 1 mm and 5 mm.

21. The vacuum extraction unit as claimed in claim 11, characterized in that the width of the gap seals formed between the end edges (33) of the side walls (32) and the workpiece surface lies in the range between 0.1 mm and 30 mm.

22. The vacuum extraction unit as claimed in claim 11, characterized in that the hood (11) is exchangeably fastened to a processing head (23), so that when processing cylindrical workpieces (24) with different diameters a hood from a number of hoods is respectively chosen and fastened to the processing head (23), the side walls (32) of which hood have end edges (33) with a contour which is adapted as well as possible to the contour of the surface of the workpiece (24) respectively to be processed.

23. The vacuum extraction unit as claimed in claim 11, characterized in that the side walls (32) of the hood are provided with means, in particular movable lamellae or exchangeable side parts, by which the contour of the edges of the side walls (32) that lie opposite a workpiece (24) can be changed in order to adapt them to the surface of the workpiece (24).

24. The vacuum extraction unit as claimed in claim 1, characterized in that, in the region of the curved directing wall (27) that lies closest to the surface of the workpiece (24) in the operating position of the hood (11), each working jet or beam, in particular working laser beam, delivered by a processing head (23) is provided with an opening (40) of its own, through which the radiation for processing the workpiece (24) is focused on the latter.
